(19) United States
(12) Patent Application Publication
(10) Pub. No.: US 2010/0157806 A1
(43) Pub. Date: Jun. 24, 2010

(54) METHOD FOR PROCESSING DATA PACKET LOAD BALANCING AND NETWORK EQUIPMENT THEREOF

(75) Inventors: Xian-Guang Song, Tianjin (CN); Tom Chen, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/342,389

(22) Filed: Dec. 23, 2008

(51) Int. Cl. H04L 12/56

(52) U.S. Cl. 370/236

(57) ABSTRACT

A method for processing data packet load balancing and a network equipment thereof, which are for balancing the load of a plurality of controllers in a network equipment. The method comprises the steps. A plurality of data packets is received. A storage queue is assigned for storing the data packets. The data packets in the storage queue are read by an allocation controller. The allocation controller assigns the data packets to different work sequences according to a work attribute of the data packets. A processing controller is commanded to perform a packet processing procedure, and at least one work queue is assigned to the processing controller for processing the data packets. After completing the packet processing procedure, the processing controller sends a completion message to a completion queue. If the allocation controller detects that the completion queue contains the completion message, the allocation controller sends the processed data packets back.

### BACKGROUND OF THE INVENTION

1. Field of the Invention

The present invention relates to a method for processing data packets and an equipment thereof, and more particularly to a method for processing data packet load balancing and a network equipment thereof.

2. Related Art

With the development and popularization of the network technology, networks have become an indispensable part of the daily life. People can quickly exchange desired information via the networks with each other. However, the Internet is not as safe as expected. For example, a computer system may be intruded by a hacker who will steal the data or destroy the computer system. Currently, most users protect their computers from being infected by a computer virus or being intruded and destroyed by other people through anti-virus software and firewalls. A technology called intrusion detection system (IDS) can be used for monitoring network activities so as to protect computers within a network from malicious attacks and destruction. The IDS is a passive network security system, which detects abnormal network activities by analyzing data packets and warns the network administrator in real-time to handle/defend against the abnormal network activities. In order to defend against malicious intrusion attacks from the network immediately, an intrusion protection system (IPS) is developed as a network security technology for providing active protection. All data packets need to pass through a network IPS, and cannot be transmitted to an internal local area network (or a network segment) to be protected unless it is determined that the data packets neither induce abnormal activities nor contain suspicious contents. Compared with the network IDS, the network IPS blocks the network attacks before any malicious intrusion occurs, thereby protecting the computer systems within the network from being destroyed.

However, as the network technology advances and the amount of data to be exchanged increases, the excessive network traffic has become a burden of the network IPS. The network IPS has to intercept and analyze every data packet, and only allows the data packets to be further transmitted after determining that the data packets do not contain malicious contents. If the response capability of the network IPS cannot keep up with the network transmission rate, the continuity of the internal network in data access will be affected, resulting in a significant degradation in the performance of the internal network.

Hence, it is proposed to process different data packets by a plurality of controllers and work queues. FIG. 1 is a schematic architectural view of a plurality of controllers and a plurality of queues in the prior art. Referring to FIG. 1, in a network equipment 100 in the prior art, each controller 110 polls every queue 120 before processing, and assigns one of the unprocessed queues 120 to the controller 110, only after which the controller starts to process the data packets in the queues 120. Although the plurality of controllers 110 may process the data packets concurrently, the controllers 110 have to wait throughout the polling process. As a result, the plurality of controllers 110 has to wait for selecting the queues to be processed, which also wastes a lot of time in waiting.

### SUMMARY OF THE INVENTION

Accordingly, the present invention is directed to a method for processing data packet load balancing, which balances the load of a plurality of controllers in a network equipment.

In order to achieve the above objective, a method for processing data packet load balancing is provided. The method includes the following steps. A network equipment receives data packets. Define one of a plurality of controllers in the network equipment as an allocation controller, and define other controllers as processing controllers. Assign a storage queue for storing the received data packets and a completion queue for storing a completion message to the allocation controller. The allocation controller assigns different work queues for storing the data packets according to a work attribute of the data packets. The processing controllers perform a packet processing procedure on the data packets in the assigned work queues respectively. After completing the packet processing procedure, the processing controllers send the completion message to the completion queue. If the allocation controller detects that the completion queue contains the completion message, the allocation controller transmits the processed data packets to a host.

The present invention is also directed to a network equipment with load balancing, which processes a plurality of data packets received by the network equipment and transmits the processed data packets to a host.

In order to achieve the above objective, a network equipment with load balancing is provided. The network equipment with load balancing includes a receiving end, an allocation controller, processing controllers, work queues, a storage queue, a packet processing procedure, and a loading lookup table. The receiving end receives data packets. The plurality of processing controllers is electrically connected to the receiving end. The processing controllers are respectively linked to at least one work queue. The allocation controller is electrically connected to the receiving end, stores the data packets into the storage queue, and performs the following steps: the allocation controller assigning the work queues for storing the data packets according to a work attribute of the data packets; commanding the processing controllers to perform the packet processing procedure, and assigning the work queues to the processing controllers for processing the data packets therein; after completing the packet processing procedure, the processing controllers sending a completion message to the completion queue; and if the allocation controller detects that the completion queue contains the completion message, the allocation controller transmitting the processed data packets to the host.

To sum up, the method for processing data packet load balancing and the equipment thereof of the present invention can invoke idle controllers in real-time. Therefore, the network packets in a system can be processed at a higher speed, and thus the network transmission rate can be increased and the packet transmission delay can be reduced.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of a plurality of controllers and a plurality of queues in the prior art;

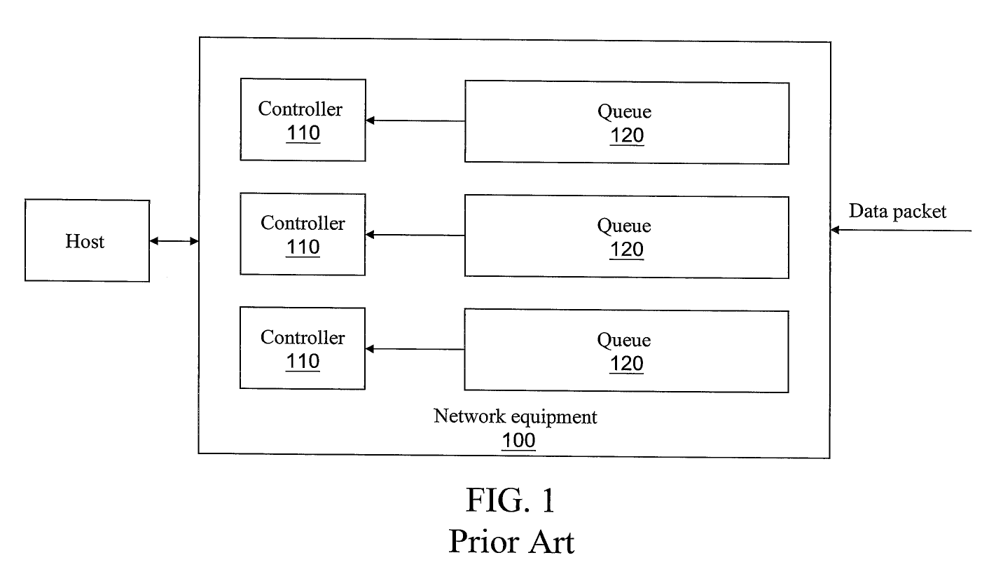

FIG. 2A is a schematic architectural view of the present invention;

FIG. 2B is a schematic architectural view of a network equipment of the present invention;

FIG. 3A is a flow chart of operations of the present invention;

FIG. 3B is a schematic flow chart of a packet processing procedure; and

FIG. 4 is a schematic view of an implementation aspect of the present invention.

### DETAILED DESCRIPTION OF THE INVENTION

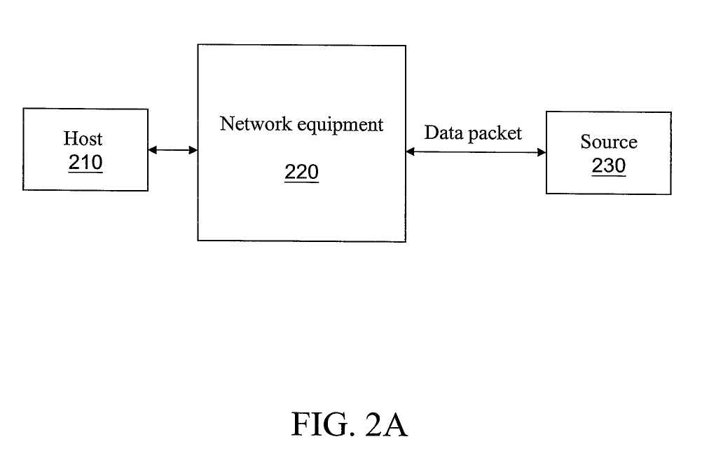

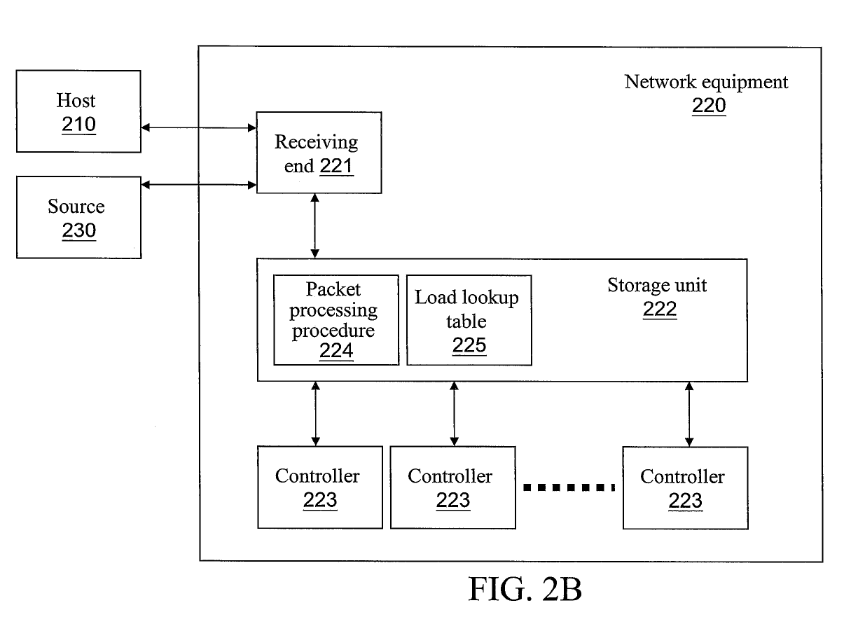

FIG. 2A is a schematic architectural view of the present invention. Referring to FIG. 2A, a host 210, a network equipment 220, and a source 230 are provided. The network equipment 220 of the present invention may be a network card, a router, a gateway, or a switcher. If the network equipment 220 is a network card, it can be disposed in the host 210. FIG. 2B is a schematic architectural view of the network equipment of the present invention. Referring to FIG. 2B, the network equipment 220 of the present invention includes a receiving end 221, a storage unit 222, controllers 223, a packet processing procedure 224, and a loading lookup table 225.

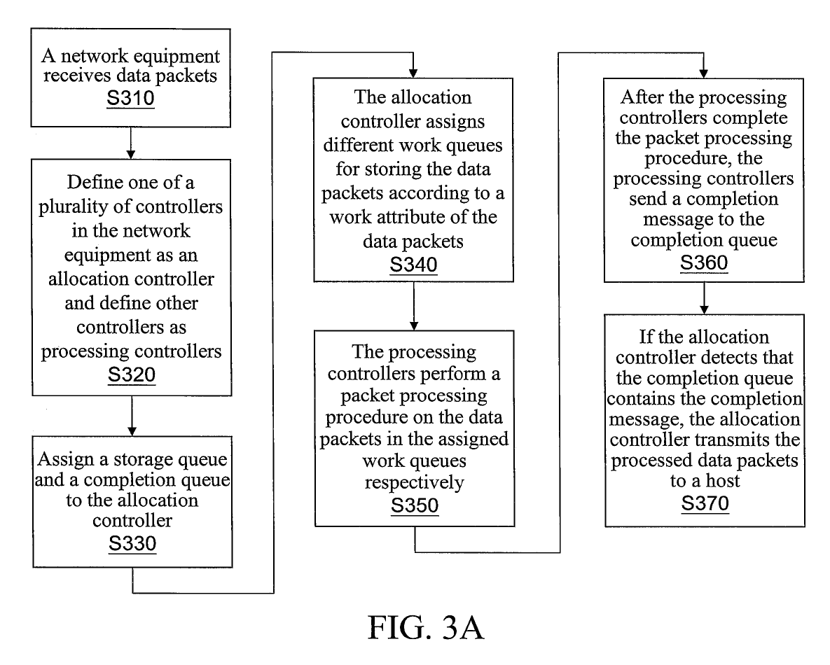

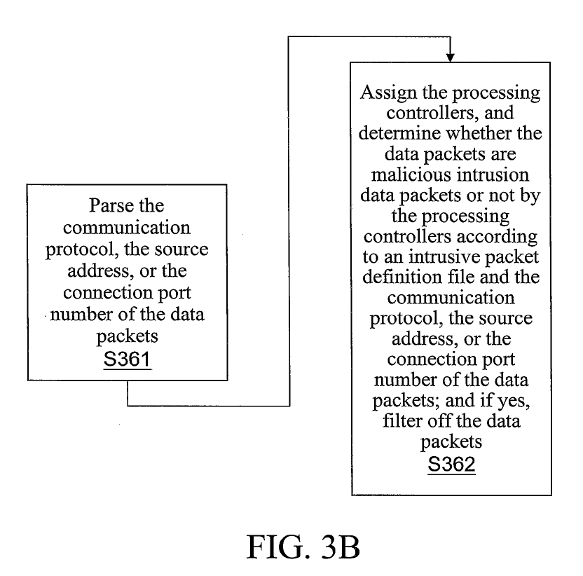

The receiving end 221 is connected to the source 230 via the Internet for receiving data packets from the source 230. The storage unit 222 is electrically connected to the receiving end 221 for storing the data packets. Besides storing the data packets, the storage unit 222 is also used for storing the packet processing procedure 224 and the loading lookup table 225. The network equipment 220 of the present invention at least includes more than two controllers 223. To clearly illustrate the operation and functions of the controllers 223, one of the controllers 223 is defined as an allocation controller and other controllers 223 are defined as processing controllers. A storage queue for storing the data packets and a completion queue for storing a completion message are assigned to the allocation controller. At least one work queue is configured for the processing controllers. The work queue is used for registering the data packets to be processed by the processing controllers. FIG. 3A is a flow chart of operations of the present invention.

Referring to FIG. 3A, the operation process of the present invention includes the following steps. A network equipment receives data packets (Step S310). One of a plurality of controllers in the network equipment is defined as an allocation controller and other controllers are defined as processing controllers. (Step S320). A storage queue for storing the received data packets and a completion queue for storing a completion message ate assigned to the allocation controller (Step S330). The allocation controller assigns different work queues for storing the data packets according to a work attribute of the data packets (Step S340). The work attribute is a communication protocol, a source address, or a connection port number. The processing controllers respectively process the data packets in the assigned work queues (Step S350). The allocation controller 2231 finds out a work queue that does not exceed a loading threshold value according to the loading lookup table 225, and assigns the work queue to the processing controllers 2232.

After completing the packet processing procedure, the processing controllers send the completion message to the completion queue (Step S360). FIG. 3B is a schematic flow chart of the packet processing procedure. Referring to FIG. 3B, the packet processing procedure further includes the steps of: parsing the communication protocol, the source address, or the connection port number of the data packets (Step S361); and assigning the processing controllers, and determining whether the data packets are malicious intrusion data packets or not by the processing controllers according to an intrusion packet definition file and the communication protocol, the source address, or the connection port number of the data packets; and if yes, filtering off the data packets (Step S362). If the allocation controller detects that the completion queue contains the completion message, the allocation controller transmits the processed data packets to a host (Step S370).

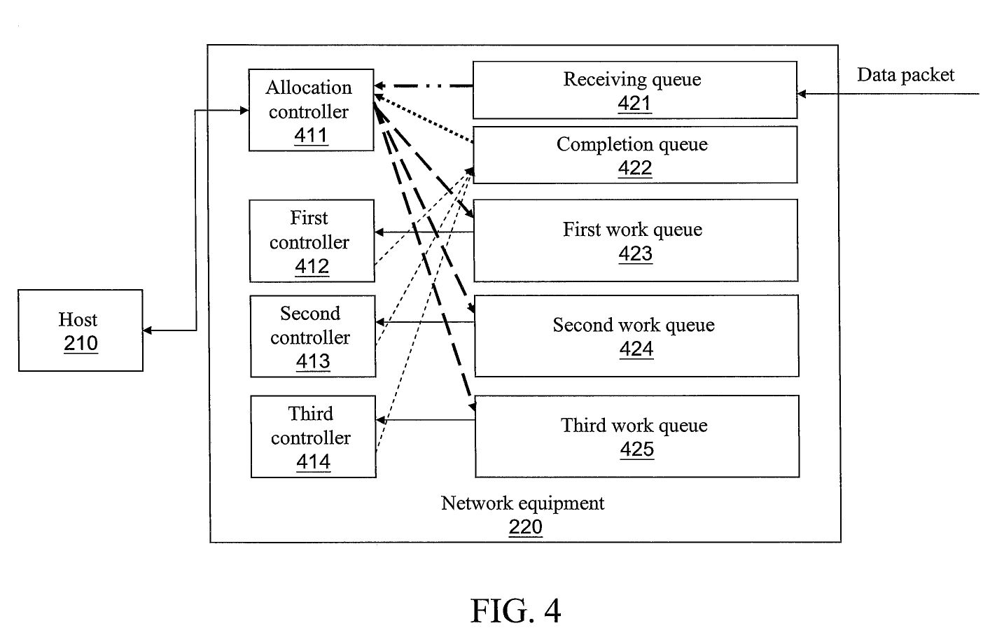

The following example is given to clearly describe the operating process of the present invention, but numbers and parameters in this example are not intended to limit the present invention. FIG. 4 is a schematic view of an implementation aspect of the present invention. Referring to FIG. 4, in this implementation aspect, four controllers (namely, an allocation controller 411, a first controller 412, a second controller 413, and a third controller 414) and five queues (namely, a receiving queue 421, a completion queue 422, a first work queue 423, a second work queue 424, and a third work queue 425) are provided. The first controller 412 is linked to the first work queue 423. The second controller 413 is linked to the second work queue 424. The third controller 414 is linked to the third work queue 425. The allocation controller 411 is linked to the receiving queue 421 and the completion queue 422.

Firstly, a receiving end 221 starts to receive data packets and stores the data packets into the receiving queue 421 in a queued manner. The allocation controller 411 detects that new data packets arrive at the receiving queue 421. The allocation controller 411 performs a packet processing procedure 224 on each of the data packets, and distributes the data packets to the first work queue 423, the second work queue 424, or the third work queue 425 according to a work attribute of the data packets. The distribution destination is selected according to Equation 1 below.

CURRENT_CPU=((MSG_INDEX++)%3)+1 Equation 1

In the equation, CURRENT_CPU is the serial number of the selected controller, and MSG_INDEX is the serial number of the data packets received by the allocation controller 411.

Moreover, the allocation controller 411 may also select the distribution destination according to numbers of the data packets stored in other queues. It is assumed that each queue is capable of storing 100 data packets, with a loading threshold value of 80%. For example, if the first work queue 423 has stored 90 data packets therein and the distribution destination selected by the allocation controller 411 according to Equation 1 is still the first controller 412, the allocation controller 411 will redistribute the data packets so as to skip over the first work queue 423, thereby reducing the load of the first controller 412.

After processing the data packets in corresponding queues, the controllers send a completion message to the completion queue 422. If the allocation controller 411 detects that the completion queue 422 contains the completion message, the allocation controller 411 transmits the processed data packets to the host 210. In such a manner, each controller can operate independently and poll the queue thereof.

To sum up, the method for processing data packet load balancing and the equipment thereof of the present invention can invoke idle controllers in real-time. Therefore, the network packets in a system can be processed at a higher speed, and thus the network transmission rate can be increased and the packet transmission delay can be reduced.

What is claimed is:

1. A method for processing data packet load balancing, for processing a plurality of data packets received by a network equipment and transmitting the processed data packets to a host, comprising:
receiving the data packets by the network equipment;
defining one of a plurality of controllers in the network equipment as an allocation controller and defining other controllers as processing controllers, and assigning a work queue to each of the processing controllers;
assigning a storage queue for storing the received data packets and a completion queue for storing a completion message to the allocation controller;
assigning the different work queues for storing the data packets by the allocation controller according to a work attribute of the data packets;
performing a packet processing procedure on the data packets in the assigned work queues by the processing controllers, respectively;
after the processing controllers complete the packet processing procedure, sending the completion message to the completion queue by the processing controllers; and
if the allocation controller detects that the completion queue contains the completion message, transmitting the processed data packets to the host by the allocation controller.

2. The method for processing data packet load balancing according to claim 1, wherein the work attribute is a communication protocol, a source address, or a connection port number.

3. The method for processing data packet load balancing according to claim 1, wherein the packet processing procedure comprises:
parsing a communication protocol, a source address, and a connection port number of the data packets; and
assigning the processing controllers, and determining whether the data packets are malicious intrusion data packets or not by the processing controllers according to an intrusive packet definition file and the communication protocol, the source address, and the connection port number of the data packets; and if yes, filtering off the data packets.

4. The method for processing data packet load balancing according to claim 1, wherein the network equipment further comprises a loading lookup table for recording numbers of the data packets stored in the work queues.

5. The method for processing data packet load balancing according to claim 4, wherein the allocation controller finds out a work queue that does not exceed a loading threshold value according to the loading lookup table, and assigns the work queue to the processing controllers.

6. A network equipment with load balancing, for processing a plurality of data packets received by the network equipment and transmitting the processed data packets to a host, comprising:
a receiving end, for receiving the data packets;
a plurality of processing controllers, electrically connected to the receiving end, and respectively linked to at least one work queue; and
an allocation controller, electrically connected to the receiving end, for storing the data packets into a storage queue and performing:
assigning the work queues for storing the data packets by the allocation controller according to a work attribute of the data packets;
commanding the processing controllers to perform a packet processing procedure, and assigning the work queues to the processing controllers for processing the data packets therein;
after the processing controllers complete the packet processing procedure, sending a completion message to a completion queue by the processing controllers; and
if the allocation controller detects that the completion queue contains the completion message, transmitting the processed data packets to the host by the allocation controller.

7. The network equipment with load balancing according to claim 6, further comprising a loading lookup table for recording numbers of the data packets stored in the work queues.

8. The network equipment with load balancing according to claim 7, wherein the storage queue is for storing the received data packets, the packet processing procedure, and the loading lookup table.

9. The network equipment with load balancing according to claim 6, wherein the work attribute is a communication protocol, a source address, or a connection port number.

10. The network equipment with load balancing according to claim 6, wherein the allocation controller finds out a work queue that does not exceed a loading threshold value according to the loading lookup table, and assigns the work queue to the processing controllers.
